(19) United States
(12) Patent Application Publication
(10) Pub. No.: US 2026/0346532 A1
(43) Pub. Date: Nov. 5, 2026

(54) METHOD FOR CONTROLLING A METHOD FOR FORMING PLASTICS CONTAINERS

(71) Applicant: SIDEL PARTICIPATIONS, Octeville-sur-Mer (FR)

(72) Inventors: Nicolas LANGLOIS, OCTEVILLE- SUR-MER (FR); Guy FEUILLOLEY, OCTEVILLE-SUR-MER (FR); Mikael DERRIEN, OCTEVILLE-SUR-MER (FR)

(21) Appl. No.: 19/116,751

(22) PCT Filed: Sep. 28, 2023
(86) PCT No.: PCT/EP2023/076850

§ 371 Date: Mar. 28, 2025

(30) Foreign Application Priority Data
Sep. 30, 2022 (FR) FR2209955

(51) Int. Cl. B29C 49/78; B29C 49/12; B29C 49/64; B29L 31/00

(52) U.S. Cl. CPC B29C 49/78; B29C 49/12; B29C 49/6418; B29C 2049/7875; B29L 2031/7158

(57) ABSTRACT

Described is a method for controlling a method for forming preforms made of thermoplastic material. The forming includes heating the preform, introducing the preform into a mold, and a stretching operation consisting in moving an elongation rod, the elongation rod passing through a position of impact with a bottom of the preform. The control method includes measuring the length between a neck and the bottom of a preform that is performed after the heating operation and before the operation of introduction into the mold, and of adjusting the impact position of the elongation rod on the basis of a measurement of the length made during the measurement step.

### TECHNICAL FIELD OF THE INVENTION

The invention relates to the production of containers such as bottles or pots made by stretch-blow-molding preforms made of thermoplastic material such as polyethylene terephthalate (PET) or recycled polyethylene terephthalate (rPET).

The invention more particularly concerns a method of producing containers made of plastic material, such as PET, by stretch-blow-molding preforms in a mold using a shaping fluid under pressure, in particular compressed air.

### TECHNICAL BACKGROUND

Such a production installation generally includes a control system, a heating station and a blow-molding station. The blow-molding station comprises at least one blow-molding workstation that includes a mold into which each of the preforms coming from the heating station is introduced in order to undergo an operation of forming a container. The forming operation includes a preform stretching step (also known as an elongation step) using an elongation rod that is associated with the mold and is driven to slide toward the bottom of the mold.

The stretching and the blow-molding of the body of a preform require the latter to be raised to a temperature above the glass transition temperature of the material. There is therefore first carried out a heat treatment of the preform by causing it to circulate in a heating station. The heating station includes heating means formed for example by infrared lamps. The preform is moved in the heating station by a conveyor.

The heated preform is then introduced into the mold after which it is stretched by means of a sliding rod (known as the stretching rod or the elongation rod). Gas under pressure is also introduced into the preform to transform it into a container by blow-molding.

The introduction of the gas under pressure includes in all cases a blow-molding step proper that consists in introducing into the preform a forming fluid, generally air, at a high pressure (typically between 18 and 40 bar). The blow-molding step is usually preceded by a first or pre-blow-molding step that consists in introducing a gas at a lower pressure (between 8 and 15 bar) while the elongation rod, having reached the bottom of the preform, stretches the latter longitudinally. The stretching, pre-blow-molding and blow-molding steps (also known as stretching and blow-molding steps) are carried out in a predefined sequence when setting the parameters of the production installation, which sequence takes into account the preforms used and the shape of the container to be obtained. Stretching and blow-molding (or pre-blow-molding and blow-molding) enable the material constituting the preform to undergo a molecular bi-orientation that confers particular mechanical properties on the finished container. Pre-blow-molding starts the deformation of the preform to transform it into a container and blow-molding enables optimal imprinting in the mold in order for the details of the container to be clearly marked.

In the remainder of the description, unless otherwise specified, the expression “blow-molding process” will be used interchangeably to designate either a sequence comprising a pre-blow-molding step followed by a blow-molding step or a process comprising only a blow-molding step. Consequently, the expression “to be begin the blow-molding process” will mean either beginning the pre-blow-molding step by injecting the pre-blow-molding gas if such a step exists or directly starting the blow-molding step by injecting the blow-molding gas.

After a certain time of contact of the plastic material with the mold, during a degassing step the pressure in the container is returned to atmospheric pressure before evacuating the finished container from the mold.

The preforms are generally obtained by injection of material into dedicated injection molds.

They have a cylindrical tubular body closed at one of its axial ends and open at its other end by a neck that is also tubular. The neck of the preform is generally injection molded in such a manner as already to have the shape of the neck of the finished container, while the body of the preform is required to undergo a relatively large deformation to form the body of the finished container following the blow-molding operation. The neck of the preforms often includes a flange intended to hold them onto the upper edge of the molds during the formation of the containers.

A container includes a lateral wall (also known as a body), a neck that extends from an upper end of the body and a bottom that extends from a lower end of the body opposite the neck.

The bottom of the container defines a seating, generally where it is joined to the body, via which the container can stand on a plane surface (such as a table).

The mold comprises a wall defining a cavity intended to impart its shape to the body of the container. This cavity is closed at a lower end by a mold bottom intended to impart its shape to the bottom of the container.

At present, to set the parameters of an installation for producing a given type of container there is placed in a mold of the installation, when the latter is shut down, an injection-molded preform (therefore cold and not having undergone heating) corresponding to those that will be used for this type of container, after which the position of the elongation rod is determined when it reaches the bottom of the preform. The position at which the end of the elongation rod reaches the bottom of the preform is conventionally termed by the applicant the “Point 0” of the elongation. From the Point 0, continued movement of the elongation rod causes elongation of the preform. When setting the parameters a position is also established of the elongation rod at which the blow-molding process has to be started, which may correspond to the Point 0 or be situated beyond that point. In other words, a theoretical stretching length is determined between the Point 0 and the start point of the blow-molding process. Indeed, as soon as the preform starts to be stretched, if nothing else is done, the material constituting the preform tightens onto the elongation rod. A first consequence of this is a risk of excessive cooling of the zones of the preform in contact with the elongation rod (the latter is generally cold), resulting in a container of lesser quality, because it thereafter becomes impossible to deform these zones correctly because of the cooling thereof. Another consequence is a risk of the elongation rod damaging, notably piercing, the bottom of the preform.

Other operations have parameters set between the moment at which the elongation rod reaches the bottom of the preform and that at which the bottom of the preform, driven by the elongation rod, reaches the bottom of the mold (termed the Point 10). Further operations take place after reaching the Point 10.

This procedure has various drawbacks. Indeed, the Point 0 is determined when the installation is stopped on a cold preform from the injection-molding press.

Now, it has been found that following heating in the heating station, the length of the body of some preforms could vary, the difference possibly reaching 5 to 10 mm from one preform to another. In particular, it has been found that for thin preforms used to produce small bottles, for example 0.5 liter bottles, with thin walls, the length of such preforms on leaving the heating station could be more than 10 mm less than the length thereof at the entry of the heating station, in other words relative to their length on leaving the injection-molding press.

In the case of preforms intended to be transformed into small bottles (typically lightweight 0.5 liter water bottles), such a reduction of length, also known as shrinkage by the person skilled in the art, corresponds to a longitudinal variation of approximately 15%. This reduction is also accompanied by an increase in the diameter of the preform. Diameter increases of approximately 7% have been noted for the same type of bottle. Also, for the same preform production process differences of a few mm between the maximum shrinkage and the minimum shrinkage can exist.

The shrinkage occurring during heating of the preforms results from the generation of stresses in the preforms during production thereof. The stresses appear because of the pressures or the temperature to which the material is subjected during injection-molding.

During heating, some of the stresses are relieved with a consequent reduction of the length and increase of the diameter of the preforms. The stress relief is sometimes known as “relaxation”.

Furthermore, the shrinkage of the preforms also depends on the temperature to which they are heated in the heating station. Accordingly, between the preforms entering the heating station just after it is started up and preforms entering the heating station after an hour in operation the temperature difference may be sufficient for the shrinkage to be visibly greater in the hotter preforms.

Moreover, in that some preforms will have become shorter than others before they are introduced into the mold, the effective stretching will commence before reaching the Point 0 determined during the setting of parameters. Now, the stretched length of the preform before the start of pre-blow-molding considerably influences the distribution of the material of the packaging (for some containers there must be no stretching). Also, if stretching commences too soon relative to pre-blow-molding or if stretching occurs when it should not and if the shrinkage is different from one preform to another different distributions of material will appear in the containers, with a risk of the material tightening onto the elongation rod, a risk that is all the greater if the containers are produced with high elongation.

Present-day installations are increasingly automated, which makes it possible to correct various temporal drifts of the blow-molding process. It is known (cf. the document W02008/081107 in the name of the applicant) to correlate singular points of a real blow-molding curve with the parameters of the installation (notably the pre-blow-molding flowrate or pressure) and to apply corrections to the parameters as a function of the divergences noted at these singular points. However, automation does not enable correction of defects such as those mentioned hereinabove. Indeed, one or more drifts occasioned by the modifications of the physical characteristics of a preform cannot be corrected by the regulation method described in the document W02008/081107 cited above.

A first object is to remedy these drawbacks by proposing a method enabling improvement of the forming of the containers produced while limiting rejects and maintaining—or even increasing—the production throughput.

Another object is a method that can if necessary be employed in an automated production installation such as that referred to in the document W02008/081107 cited above.

In the remainder of the description by “forming” is more particularly meant distribution of the material.

### SUMMARY OF THE INVENTION

The invention proposes a method for controlling a method for forming containers by stretch-blow-molding preforms made of thermoplastic material, notably PET, each preform including a body one end of which is open via a neck and an opposite end is closed by a bottom, the forming method comprising, for each preform moving along a production trajectory:
an operation of heating the preform to a predetermined temperature in a heating zone;
an operation of introducing the heated preform into a mold in a zone of the production trajectory;
a stretching operation consists in moving an elongation rod in order to stretch the preform, the elongation rod passing during its movement through an impact position at the moment it comes into contact with the bottom of the preform.

The control method carried out in accordance with the teachings of the invention is characterized in that it includes:
at least one step of measuring the length between a reference point on the neck and the bottom of a preform that is carried out after the operation of heating said preform and before the operation of introducing said preform into the mold;
a step of adjusting the impact position of the elongation rod on the basis of at least one measurement of the length carried out during at least one measuring step.

In accordance with another aspect of the control method carried out in accordance with the teachings of the invention, the reference point on the neck is formed by a lower bearing surface of a flange of the neck or by a mouth of the neck.

In accordance with another aspect of the control method carried out in accordance with the teachings of the invention, the forming method includes a blow-molding process consisting in injecting a forming fluid under pressure into the preform, the start of the blow-molding process being determined as a function of the impact position of the elongation rod adjusted during the adjustment step of the control method.

In accordance with another aspect of the control method carried out in accordance with the teachings of the invention, the step of measuring the length is carried out in a measuring zone through which the production trajectory passes, the measuring zone being situated between the heating zone and the zone for introducing the preforms into the mold.

In accordance with another aspect of the control method carried out in accordance with the teachings of the invention, the heating operation is carried out in a heating station including a conveyor transporting the preforms through the heating zone, the measuring zone being on a section of the production trajectory along which the preforms are transported by said conveyor.

In accordance with another aspect of the control method carried out in accordance with the teachings of the invention, the measuring step is carried out by means of a contactless measuring device that is able to measure the length of the preform on the fly during its continuous movement along the production trajectory.

In accordance with another aspect of the control method carried out in accordance with the teachings of the invention, the measuring device includes a device for capturing an image of a passing preform in the measuring zone, the measuring step including a first sub-step of capturing an image of the preform.

In accordance with another aspect of the control method carried out in accordance with the teachings of the invention, during the image capture first sub-step the preform is illuminated by a light source situated opposite the position of the image capture device relative to the production trajectory 27.

In accordance with another aspect of the control method carried out in accordance with the teachings of the invention, the measuring step includes a second sub-step of processing the image captured during the first, capture sub-step by means of an electronic processing unit consisting in detecting at least one measurement point in the image of the bottom of the preform and then measuring in the image the distance between a reference point in the image the position of which relative to the neck of the preform is known and said measurement point in the direction of the axis of the preform, this distance then being converted into a real distance.

In accordance with another aspect of the control method carried out in accordance with the teachings of the invention, the reference point is formed by an optical axis of the image capture device.

In accordance with another aspect of the control method carried out in accordance with the teachings of the invention, the conversion of the distance measured in the image into a real distance is carried out after a calibration sub-step.

In accordance with another aspect of the control method carried out in accordance with the teachings of the invention, the calibration sub-step is carried out on each iteration of the sequence of determining the length of a preform, the calibration sub-step consisting in taking the measurement of a known mensuration of the preform, for example the outside diameter, to determine a ratio between a distance in the image and a real distance.

In accordance with another aspect of the control method carried out in accordance with the teachings of the invention, the step of adjusting the impact position is based on the length measured following each iteration of the measuring step.

In accordance with another aspect of the control method carried out in accordance with the teachings of the invention, the step of adjusting the impact position is carried out on the basis of the sliding mean value of the length measured after a plurality of iterations of the measuring step carried out successively on a plurality of preforms.

In accordance with another aspect of the control method carried out in accordance with the teachings of the invention, the measuring step is carried out at a particular frequency, for example as each preform passes through the measuring zone or for one preform from a particular number of preforms.

### BRIEF DESCRIPTION OF THE FIGURES

Other features and advantages of the invention will become apparent on reading the following detailed description to understand which reference should be made to the appended drawings described briefly below.

FIG. 1 is a view from above that schematically represents an installation in accordance with the teaching of the invention for producing containers.

FIG. 2 is a side view that represents a preform intended to feed the installation from FIG. 1.

FIG. 3 is a view in axial section that schematically represents a blow-molding workstation of the installation from FIG. 1.

FIG. 4 is a schematic side view that represents a device equipping the FIG. 1 installation for measuring the height of a preform produced in accordance with the teachings of the invention.

FIG. 5 is a front view that represents an image obtained by means of an image capture device that forms part of the measuring device represented in FIG. 4.

FIG. 6 is a block schematic that represents the control method implemented in accordance with the teachings of the invention intended to be implemented by the FIG. 1 installation.

### DETAILED DESCRIPTION OF THE INVENTION

In the remainder of the description, the terms “high” and “low” are used for reasons of clarity with reference to the orientation in the figures without this having any limiting scope.

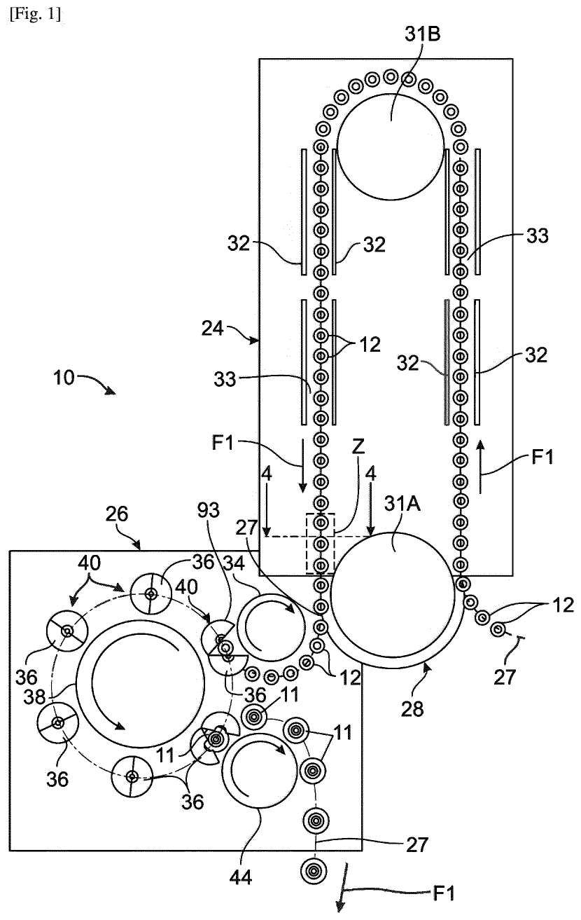

In FIG. 1 there is schematically depicted an installation 10 for producing containers 11 from preforms 12 made of thermoplastic material and more particularly PET (polyethylene terephthalate) or rPET (recycled polyethylene terephthalate).

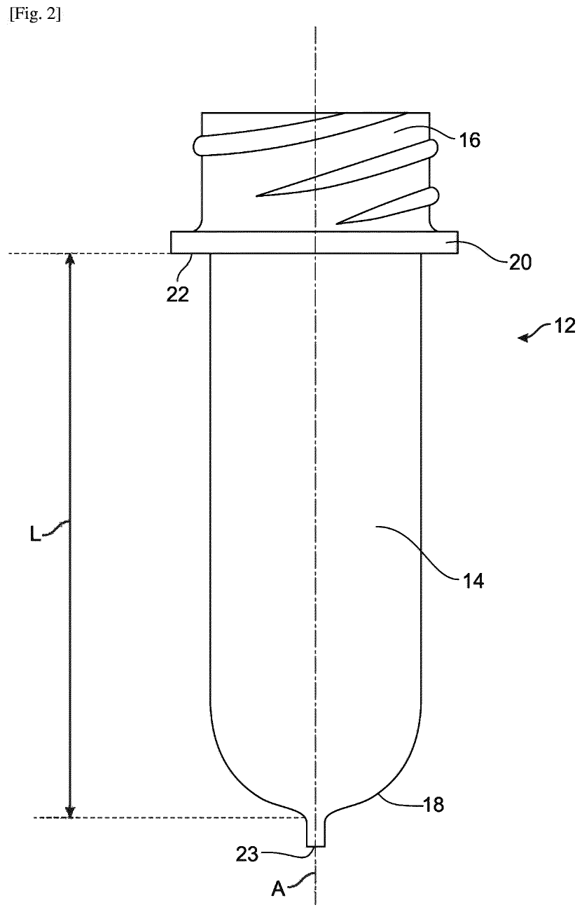

As represented in FIG. 2, each preform 12 includes a cylindrical body 14 with axis “A”. An upper end of the body 14 is open via a neck 16 with the definitive shape of that of the container 11 to be obtained (which generally does not suffer the least deformation during the production of the container). The body 14 includes a bottom 18 that closes its lower end and the shape of which is generally hemispherical. The neck 16 includes a flange 20 at its junction with the body 14. The lower face of the flange 20 is intended to form a bearing surface 22 to enable the preform 12 to be supported during molding thereof, as described hereinafter.

Following injection-molding thereof, the preforms 12 are suddenly cooled to impart an amorphous state to the thermoplastic material. It is therefore possible to render the thermoplastic material malleable again by heating it beyond a glass transition temperature.

At the level of its intersection with the axis “A” of the body 14 the bottom 18 of the preform 12 has an injection point 23 corresponding to the point of injection of thermoplastic material during injection-molding.

Referring again to FIG. 1, the production installation 10 comprises a heating station 24 and a forming station 26. The preforms 12 move in single file along a production trajectory 27 that passes through the heating station 24 and the forming station 26. The direction of movement of the preforms 12 is indicated by the arrows “F1” in FIG. 1. During normal operation of the production installation 10 the preforms 12 move constantly along the production trajectory 27.

The function of the heating station 24 is to heat the body 14 of the preforms 12 to a temperature above or equal to the glass transition temperature of the material constituting it, for example above 70 °C when the material is PET. The heating station 24 comprises a conveyor 28 (depicted schematically) for transporting the preforms 12 and causing them to turn on themselves.

The conveyor 28 generally includes mandrels 30 that nest in the neck 16 to transport the preforms 12. The mandrels 30 are moved along a closed circuit. The mandrels 30 are for example carried by the links of a chain or by independent shuttles moving along a rail.

Here the circuit includes two parallel rectilinear sections connected by 180° turn sections.

The conveyor 28 further includes two wheels 31A, 31B for guiding the mandrels 30 in the turn portions of the closed circuit.

The heating station 24 also includes heating means 32 for heating the preforms 12, for example lamps facing reflectors or laser sources that emit electromagnetic radiation in the infrared band. In a variant of the invention that is not represented the heating means emit electromagnetic radiation in the microwave band.

The heating means 32 are arranged along a heating zone 33 of the preform production trajectory 27. In the example represented in FIG. 1 the heating station 24 includes a heating zone 33 divided into two parts arranged upstream and downstream of the turn portion provided by the guide wheel 31B.

The preforms 12 enter the heating station 24 mounted on the conveyor 28 in which they follow a U-shape section of their production trajectory 27 passing through the heating zone 33. They are heated as they move by the heating means 32 which are if necessary placed on one side or on either side of the preforms 12 relative to their direction of movement. The hot preforms 12 are extracted from the heating station 24 after their passage in the heating zone 33 and transferred into molds of the forming station 26 by a first transfer device 34 such as a transfer wheel disposed between the heating station 24 and the forming station 26.

In one non-limiting embodiment the preforms 12 are heated with the neck 16 at the bottom and are turned over with the neck 16 at the top between leaving the heating zone 33 and before their removal from the conveyor 28.

The transfer wheel comprises arms (not represented as they are known in themselves) that seize the successive preforms 12 as they exit the heating station 24 at the level of their neck 16 to introduce each in turn into a mold 36 of the forming station 26. The forming station 26 comprises a carousel 38 at the periphery of which there are several blow-molding workstations 40.

Each blow-molding workstation 40 comprises at least one mold 36 that is usually in three parts, that is to say two half-molds 36A, 36B and a mold bottom 36C which together define a cavity 42 having the imprint of the container 11.

Each hot preform 12 leaving the heating station 24 is introduced into a mold 36 of the blow-molding workstation 40 to be blow-molded therein and transformed into a container 11. Once finished the container 11 is extracted from the blow-molding workstation 40 by a second transfer device 44 similar to the first transfer device 34 and well known to the person skilled in the art. The cavity 42 of the mold 36 includes an upper axial passage to let the neck 16 of the preform 12 leave the cavity 42. Thus the body 14 is received in the cavity 42 while the neck 16 remains above the cavity 42, the preform 12 being held in position by contact between the bearing surface 22 of its flange 20 and the perimeter of the passage. The position of the bearing surface 22 of the flange 20 therefore constitutes an invariant fixed point for any preform 12 introduced into an associated mold 36.

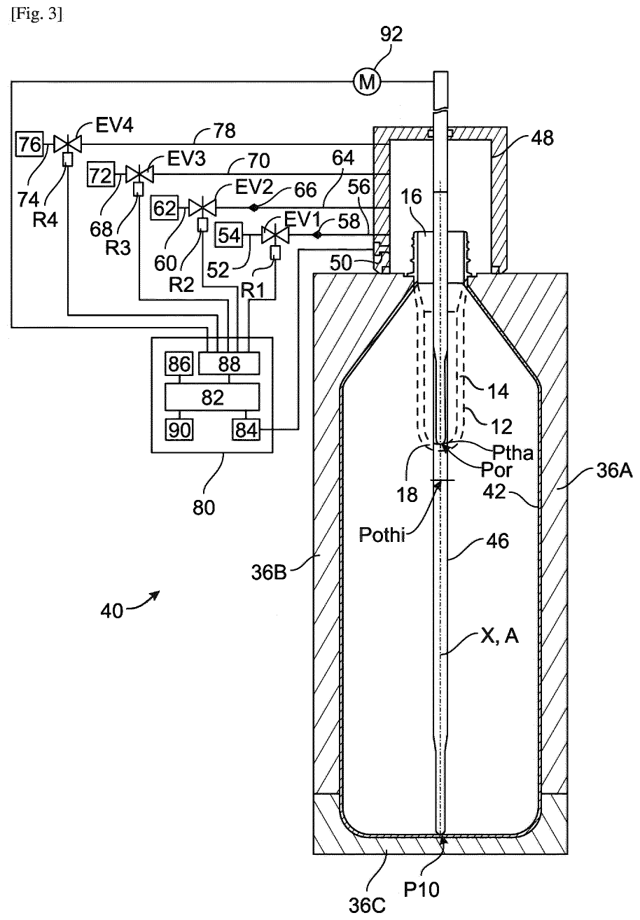

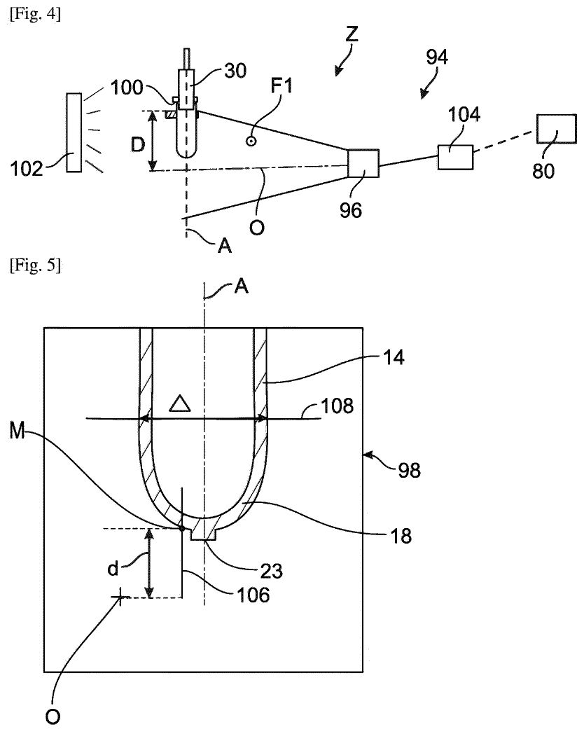

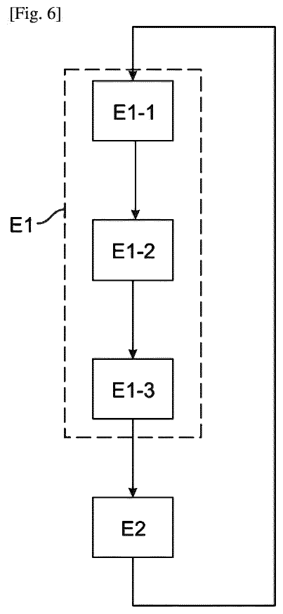

In FIG. 3 a blow-molding workstation 40 is shown in detail. It comprises the mold 36, made of steel or aluminum alloy for example, consisting of two half-molds 36A, 36B and a mold bottom 36C defining the cavity 42 the perimeter of which is the shape of the finished container 11 produced. The mold 36 is intended to receive the successive hot preforms 12 coming from the heating station 24.

The blow-molding workstation 40 also includes an elongation rod 46 mobile along a main axis X of the mold 36 between a high position enabling introduction of a preform 12 into the mold 36 when the latter is open and a low position in which the end of the elongation rod 46 has stretched the preform 12 until its bottom 18 is in contact with the mold bottom 36C, indicated by the reference “P10”. The elongation rod 46 passes from the high position to the low position in order to stretch the material of the preform 12 axially along the axis X of the mold, which here is coaxial with the axis “A” of the preform 12. As explained in the preamble, between its high position and its low position P10 the elongation rod 46 passes through a point of impact P0 at the moment at which it comes into contact with the internal face of the bottom 18 of the preform 12.

The blow-molding workstation 40 further includes a blow-molding nozzle 48 mobile between a high position during the introduction of the preform 12 and a low position in which the lower end of this nozzle 48 comes to cap and seal the preform 12 in order to feed the forming fluid, notably air, into the preform 12 via its neck 16 to press the plastic material against the walls of the mold 36. The elongation rod 46 slides in the nozzle 48.

The blow-molding workstation 40 also includes a pressure sensor 50 opening into the nozzle 48 to measure therein the pressure in the closed volume consisting of the nozzle 48 and the preform 12 during the operation of forming the container 11.

The blow-molding workstation 40 includes a pre-blow-molding forming circuit 52 at a pre-blow-molding pressure between 3 and 15 bar. This circuit 52 provides a source 54 of low pressure and a pipe 56 for feeding the forming fluid from the source 54 of low pressure to the nozzle 48 to form the container 11 and a so-called pre-blow-molding solenoid valve EV1 enabling the source 54 of low pressure to communicate with the interior of the preform 12 via the nozzle 48.

The solenoid valve EV1 is located on the pipe 56 between the source 54 of low pressure and the nozzle 48. The pre-blow-molding fluid circuit 52 further includes a check valve 58 preventing fluid coming from another source or contained in the preform 12 (respectively the container) from being introduced into it.

The blow-molding workstation 40 also includes a blow-molding fluid circuit 60 at a blow-molding pressure between 15 and 40 bar that comprises a source 62 of high pressure and a pipe 64 enabling the fluid to be fed from the source 62 of high pressure to the nozzle 48 to form the container 11 and a so-called blow-molding solenoid valve EV2 controlling the communication of the source 62 of high pressure with the preform 12.

The solenoid valve EV2 is placed on the pipe 64 between the source 62 of high pressure and the nozzle 48. The blow-molding fluid circuit 60 further includes a check valve 66 preventing fluid from another source or contained in the preform 12 (respectively the container) from being introduced into it.

The blow-molding workstation 40 also includes a circuit 68 for recovering the forming fluid that comprises a pipe 70 enabling the forming fluid contained in the container after it is produced to be fed to recovery means 72 such as a recovery tank or circuit and a so-called recovery solenoid valve EV3 controlling communication between the container and the recovery means.

The solenoid valve EV3 is installed on the pipe 70 of the recovery circuit 68.

The blow-molding workstation 40 includes a degassing circuit 74 enabling communication between the interior of the container and the exterior for the return to atmospheric pressure before the nozzle 48 is raised to the high position, the degassing circuit 74 comprising a vent loop one end of which is connected to a silencer 76 to prevent all noise and the other end of which is connected to a pipe 78 connected to the nozzle 48, and a so-called degassing solenoid valve EV4 controlling communication of the forming fluid contained in the container 11 with the atmosphere.

The blow-molding workstation 40 includes an electronic control unit 80, notably in the form of an industrial programmable automatic controller (API). The electronic control unit 80 is electrically connected to the solenoid valve EV1 controlling pre-blow-molding via an actuator R1. Triggering a pre-blow-molding phase by injecting the forming fluid at the pre-blow-molding pressure is therefore controlled by the electronic unit 80.

The electronic control unit 80 is also electrically connected to the pressure sensor 50 and to the solenoid valves EV2, EV3, EV4 via respective actuators R2, R3, R4 the function of which is to open and/or close the solenoid valves EV2, EV3, EV4.

In the embodiment represented in FIG. 3, without this being limiting on the invention, the electronic control unit 80 comprises a processor 82, an analog input module 84 connected to the pressure sensor 50 to collect measurements therefrom and to convert them into a digital signal in order for them to be processed by the processor 82, a memory 86 connected to the processor for storing data from the pressure sensor 50 (after conversion), an analog output module 88 controlled by the processor 82 and controlling the solenoid valves EV1, EV2, EV3, EV4 via the actuators R1, R2, R3, R4 in such a manner as to modulate the opening and the closing to vary the flowrate of fluid fed to the nozzle 48, and the device controlling the axial movement of the elongation rod 46, a communication interface 90 for execution in the electronic control unit 80 of the program controlling this operation.

In one embodiment the electronic control unit 80 is also electrically connected to the means 92 for driving the elongation rod 46 to control its movement. The driving means 92 consist of an electric motor. The analog output modulator 88 also receives from the electric motor data on the position of the elongation rod 46.

The production installation 10 functions in a similar way to known installations except that the production installation 10 uses a control method in accordance with which the theoretical impact position P0tha of the elongation rod 46 is continually adjusted during functioning thereof, the adjusted theoretical impact position P0tha being closer to or even coincident with the real impact position P0r relative to the initial theoretical impact position P0thi.

Thus the method of producing a container 11 includes an operation of heating the body 14 of the preform 12 to a predetermined temperature, notably above the glass transition temperature, by passing the preform 12 through the heating zone 33.

Following the heating operation, the method includes an operation of introducing the heated preform 12 into the mold 36 in an associated zone 93 represented in FIG. 1.

Following this operation, the method includes a stretching operation consisting in moving an elongation rod 46 in order to stretch the preform 12 introduced into the mold 36, the elongation rod 46 passing as it moves from its high position to its low position P10 through the real impact position P0r at the moment it comes into contact with the bottom 18 of the preform 12.

The forming method also includes a pre-blow-molding operation consisting in injecting the forming fluid under pressure, notably at the pre-blow-molding pressure, into the preform 12.

The instruction to start the blow-molding process is sent as a function of this adjusted impact position P0tha and not as a function of the initial theoretical impact position P0thi determined from a cold preform 12, as explained in the preamble to the description.

In FIG. 3, in which the preform 12 is depicted in dashed line, the real impact position P0r of the elongation rod 46 when stretching has not yet begun is indicated. Assuming that the preform 12 shrank during its heating in the heating station 24 by the heating means 32, the initial theoretical impact point P0thi used in the earlier methods would be found slightly farther along the travel of the elongation rod 46, as depicted in FIG. 3.

The theoretical impact position P0th of the elongation rod 46 can be adjusted by measuring the length of at least one preform 12 after it is heated and before it is introduced into the mold 36. To be specific, the length “L” of the preform 12 is measured between the bottom 18 and a reference point on the neck 16.

During heating, only the body 14 of the preform 12 expands significantly. The neck 16 of the preform 12 remains sufficiently cold for its dimensions not to vary. In particular, the height “h” of the section of the neck 16 located axially between the mouth and the bearing surface 22 of the flange 20 remains substantially invariant during heating. Thus once the length “L” of the preform 12 between the reference point on the neck 16 and the bottom 18 has been obtained it is easy to find out the axial distance between any point on the neck 16 and the bottom 18.

The reference point on the neck 16 is for example formed by the bearing surface 22, the latter forming a fixed reference point relative to the mold 36.

Alternatively, the reference point on the neck 16 is formed by an upper edge of the neck 16, also known as the mouth.

The method for controlling the forming operation therefore includes at least one step “E1” of measuring the length “L” of a preform 12. As represented in FIG. 2 the length “L” is measured parallel to the axis “A” of the preform 12 between the bearing surface 22 of the flange 20 and the bottom 18 of the body of the preform 12.

Advantageously, but not necessarily, to obtain a more precise measurement the length “L” extends axially from the bearing surface 22 to a point on the external face of the bottom 18 that is situated in the immediate vicinity of the injection point 23. Indeed, the size of the injection point 23 is random from one preform 12 to another, which would slightly falsify a length measured between the injection point 23 and the bearing surface 22.

The measuring step “E1” is carried out after the operation of heating said preform 12 and before the operation of introducing said preform 12 into the mold 36.

The step “E1” of measuring the length “L” is more particularly carried out in a measuring zone “Z” through which passes the production trajectory 27 of the preforms 12. As represented in FIG. 1, the measuring zone “Z” is situated between the exit from the zone 33 for heating the preforms 12 and the start of the operation of introducing the preforms 12 into the mold 36.

In the example represented in FIG. 1 the measuring zone “Z” is on a section of the production trajectory 27 along which the preforms are transported by the conveyor 28 of the heating station 24. The measuring zone “Z” is therefore downstream of the heating zone 33 and upstream of the first transfer device 34.

When the preforms 12 are heated with the neck 16 at the bottom and then turned over with the neck 16 at the top before being transferred to the first transfer device 34 the measuring zone “Z” is advantageously downstream of the point at which they are overturned with the neck at the top so that the preforms 12 pass through the heating zone 33 with the neck 16 at the bottom.

The measuring step “E1” is carried out by means of a contactless measuring device 94 that is able to measure the length “L” of the preform 12 on the fly, that is to say during its continuous movement along the production trajectory 27.

The measuring device 94 includes a device 96 for capturing an image 98 of a preform 12 in the measuring zone “Z”. The image capture device 96 is more particularly adapted to capture an image 98 of at least one lower end section of the body 14 including the bottom 18, as represented in FIG. 5.

The image capture device 96 is fixed relative to the floor on which the production installation 10 stands.

The image capture device 96 has an optical axis “O” that is orthogonal to the axis “A” of the preform 12. The optical axis “O” is at a known axial distance “D” from the bearing surface 22 of the flange 20 of the preform 12. This is possible in particular because the mandrel 30 that carries the preform 12 has an abutment face 100 against which the mouth of the neck 16 of the preform bears when the mandrel 30 is nested in the neck 16. The distance “D” therefore also corresponds to the distance between the abutment face 100 of the mandrel 30 and the optical axis “O”. The abutment faces 100 of all the mandrels 30 of the conveyor 28 are of course arranged at the same level so that the distance “D” remains the same for each mandrel 30.

The optical axis “O” is here arranged substantially orthogonally to the direction “F1” of movement of the preform 12 in the measuring zone “Z”.

To improve the quality of the image 98 of the preform 12 and thus to enable more precise processing of that image 98, the measuring device 94 also includes a light source 102 that is arranged opposite the image capture device 96 relative to the production trajectory 27 in the measuring zone “Z”. The light source 102 is activated during image capture by the image capture device 96 so that the preform 12 has passed through it a light beam emitted by the light source 102 and this light beam then reaches the image capture device 96. This enables a sharper image 98 with high contrast to be obtained, while reducing the time necessary for imaging, for example to less than 1/100 second.

The measuring device 94 also includes an electronic processing unit 104 that includes the structural and software components necessary to process the image 98 obtained by the image capture device 96. This electronic processing unit 104 is electrically connected to the electronic control unit 80 of the forming workstation 40.

The measuring step “E1” includes a first sub-step “E1-1” of capturing an image 98 of a preform 12 passing through the measuring zone “Z”.

The measuring step “E1” then includes a second sub-step “E1-2” of processing the image 98 captured during the first, image capture sub-step “E1-1”. This second, processing sub-step “E1-2” is carried out by means of the electronic processing unit 104, which receives the image 98 transmitted by the image capture device 96.

This second processing sub-step “E1-2” consists in detecting at least one measurement point “M” in the image 98 of the bottom 18 of the preform 12 and then measuring in the image the distance “d” between the reference point in the image the position of which relative to the neck 16 of the preform 12 is known and said measurement point “M” in the direction of the axis “A” of the preform 12, this distance “d” then being multiplied by a particular ratio to obtain an estimate of the real distance “D”.

Here the reference point is formed by the optical axis “O” of the image capture device 96 that is indicated here by a cross on the image 98. The position of the optical axis “O” is indeed always situated at the same location on the captured image 98. This information is a datum stored in the electronic processing unit 104.

The position of the measurement point “M” is determined by working back along an axial measuring line 106 that is located by default at a particular distance from the axis “A” of the preform 12, for example 4 mm from the axis “A” of the preform 12. The line 106 intentionally extends below the initial theoretical position of the bottom 18 so that at the bottom of this line 106 the pixels are white because of the effect of the light source 102. The point “M” is detected when the pixels of the image become much darker along this line 106.

The position of the axis “A” of the preform 12 is for example determined by an analysis of the shape of the curvature of the bottom 18 or by measuring an outside diameter of the body 14 and then taking the center of that diameter.

Alternatively, the position of the axis “A” of the preform 12 can also constitute a datum stored in the electronic processor 104 if the image 98 is always captured at precisely the same place in the measuring zone “Z”.

The distance measured in the image is converted into a real distance after a calibration sub-step “E1-3”.

Here the calibration sub-step “E1-3” is carried out on each iteration of the first measuring step “E1”. The calibration sub-step “E1-3” consists for example of taking the measurement of a known mensuration of the preform 12 to determine a ratio “r” between a distance of the image 98 and a real distance.

The mensuration is for example the outside diameter “A” of the body 14. Indeed, heating the preform 12 has no significant effect on the outside diameter “A” of the body 14 of the preform 12. The outside diameter “A” measured on a cold preform 12 is therefore substantially equal to the outside diameter “A” of the body 14 of a heated preform 12. The outside diameter “A” is measured along a transverse line 108 through the body 14 by detecting the change of contrast of the pixels of the image 98. The outside diameter “A” in the image really measured on a cold preform is then divided by the outside diameter “A” measured on the image to form the ratio “r”.

In a variant of the invention that is not represented the calibration sub-step “E1-3” is carried out only once before the production installation 10 starts to operate. The ratio “r” is therefore a datum stored in the electronic processing unit 104. This can apply in particular if the image 98 captured is always captured at precisely the same place in the measuring zone “Z”, the distance between the image capture device 96 and the preform 12 therefore remaining constant for each measurement. The ratio “r” therefore always remains the same for each image 98 captured.

The length “L” of the preform 12 is therefore calculated using the following formula:

L=D−(d×r)−h

in which L is the measured length of the preform 12, D is the distance between the bearing surface 22 and the optical axis “O”, d is the distance between the measurement point M and the optical axis “O” measured in the image 98, r is the multiplier ratio for obtaining the real distance from a distance measured in the image 98, and “h” is the axial height of the neck 18 between the mouth and the bearing surface 2.

Following one or more first measuring steps “E1”, a step “E2” is triggered adjusting the impact position “P0th” of the elongation rod 46. This second step “E2” consists in replacing the preceding value of the theoretical impact position “P0th” on the basis of at least one measurement of the length obtained during at least one measuring step “E1”.

This therefore enables optimum adaptation of the triggering of the blow-molding process taking into account the shrinkage of the preforms 12 after heating them. This is a continuous adaptation that also makes it possible to take into account the fact that the heating station 24 can heat the preforms 12 more or less during its period of continuous operation.

To this end, the electronic processing unit 104 transmits the measured value of the length “L” of the preform 12 to the electronic control unit 80, which enables the latter to calculate a new theoretical point “P0tha” taking into account for example the thickness of the bottom 18 of the preforms 12.

The step “E2” of adjusting the impact position is for example based on the length “L” measured after each iteration of the measuring step “E1”. However, there is a risk of this causing too great a change of the impact position by virtue of taking into account extreme values for the measuring length “L”.

The step “E2” of adjusting the impact position is therefore preferably carried out on the basis of the mean value of the length “L” measured after a plurality of iterations of the measuring step “E1”, for example ten iterations, carried out successively on a plurality of preforms 12.

This therefore enables smoothing of the signal for adjustment of the impact position by avoiding excessive variations that could have a counter-productive effect.

This means for example a sliding mean value that makes it possible to obtain continuous adjustment of the theoretical impact position “P0tha” on each iteration of the measuring step “E1”.

Each measuring step “E1” is carried out at a particular frequency.

An iteration of the first measuring step “E1” is generally very rapid, taking for example around 20 ms. This makes it possible to carry out the measuring step “E1” for all the preforms 12 passing successively in the measuring zone “Z”. The frequency at which the measuring step “E1” is iterated therefore corresponds to the frequency of passage of the preforms 12 in the measuring zone “Z”.

Alternatively, the measuring step “E1” is not carried out for each preform 12. For example, the first measuring step “E1” is iterated for the passage of one preform from a certain number of preforms 12, for example one preform in two or one preform in three. The frequency at which the measuring step “E1” is iterated is therefore achieved by division of the frequency of passage of the preforms 12 in the measuring zone “Z”.

The invention is particularly suitable for thin and light preforms for which the orientation levels are high and the heating applied is therefore high.

The small thicknesses of preforms, of the order of 1.5 mm, that are increasingly encountered are particularly propitious to the presence of numerous constraints during injection-molding. During heating of the preform the levels of bi-orientation of the material are high and the heating applied in the heating station must be at high temperature (125 °C-135 °C). The association of this high temperature with the stresses present in the preforms will have the effect of generating shrinkage of the preforms over their length and slight expansion of their diameter.

High shrinkage essentially affects thin preforms intended to produce flat water bottles of small volume (typically less than 0.5 liter). The length of these preforms is less than 90 mm (typically between 60 and 70 mm). Shrinkage after heating in this type of preform can easily reach 10 mm, which corresponds to almost 15% shrinkage on a 70 mm preform for a diameter expansion of around 7%. The same preform with the same resin but with a reduced level of stress will after heating have a shrinkage of around 5 mm (i.e. around 7% shrinkage and 3% diameter expansion).

The invention is also particularly suitable for preforms made of rPET for which the shrinkage values are liable to vary greatly depending on the composition of the recycled material constituting them.

We claim:

1. A method for controlling a method for forming containers by stretch-blow-molding preforms made of thermoplastic material, each preform including a body at one end of which is open via a neck and an opposite end that is closed by a bottom:
wherein the forming method comprises, for each preform moving along a production trajectory:
an operation of heating the preform to a predetermined temperature in a heating zone;
an operation of introducing the heated preform into a mold in a zone of the production trajectory;
a stretching operation comprising moving an elongation rod configured to stretch the preform, the elongation rod passing during the moving through an impact position when the elongation rod comes into contact with the bottom of the preform; and
wherein the control method comprises:
at least one step of measuring a length between a reference point on the neck and the bottom of the preform, wherein the measuring is carried out after the operation of heating the preform and before the operation of introducing the preform into the mold;
a step of adjusting the impact position of the elongation rod on the basis of at least one measurement of the length carried out during the at least one measuring step.

2. The method as claimed in claim 1, wherein the forming method further comprises a blow-molding process, the blow-molding process comprising injecting a forming fluid under pressure into the preform, wherein the start of the blow-molding process is determined as a function of the impact position of the elongation rod adjusted during the adjustment step of the control method.

3. The method as claimed in claim 1, wherein the step of measuring the length is carried out in a measuring zone through which the production trajectory passes, the measuring zone being situated between a heating zone and a zone for introducing the preforms into the mold.

4. The method as claimed in claim 3, wherein the heating operation is carried out in a heating station, the heating station comprising a conveyor transporting the preforms through the heating zone, the measuring zone being on a section of the production trajectory along which the preforms are transported by the conveyor.

5. The method as claimed in claim 1, wherein the measuring step is carried out by contactless measuring device configured to measure the length of the preform while in motion during continuous movement along the production trajectory.

6. The method as claimed in claim 5, wherein the measuring device comprises a device for capturing an image of a passing preform in the measuring zone, and wherein the measuring step includes a first sub-step of capturing an image of the preform.

7. The method as claimed in claim 6, wherein during the image capture first sub-step the preform is illuminated by a light source situated opposite the image capture device relative to the production trajectory.

8. The method as claimed in claim 7, wherein the measuring step includes a second sub-step of processing the image captured during the first capture sub-step, wherein the processing is carried out by an electronic processing unit configured to detect at least one measurement point in an image of the bottom of the preform and then measuring on the image the distance between a reference point in the image, wherein the position of the reference point relative to the neck of the preform is known, wherein the measurement points in the direction of the axis of the preform, and wherein the distance is then being converted into a real distance.

9. The method as claimed in claim 8, wherein the reference point is formed by an optical axis of the image capture device.

10. The method as claimed in claim 8, wherein the conversion of the distance into a real distance is carried out after a calibration sub-step.

11. The method as claimed in claim 10, wherein the calibration sub-step is carried out on each iteration of a sequence of determining the length of the preform, the calibration sub-step comprising taking the measurement of a known mensuration of the preform to determine a ratio between the distance in the image and the real distance.

12. The method as claimed in claim 1, wherein the step of adjusting the impact position is based on the length measured following each iteration of the at least one step of measuring

13. The method as claimed in claim 12, wherein the step of adjusting the impact position is carried out on the basis of a sliding mean value of the length measured after a plurality of iterations of the measuring step carried out successively on a plurality of preforms.

14. The method as claimed in claim 1, wherein the measuring step is carried out at a particular frequency.

15. The method as claimed in claim 14, wherein the particular frequency is as each preform passes through the measuring zone.

16. The method as claimed in claim 14, wherein the particular frequency is taken from one preform in a particular number of preforms.

17. The method as claimed in claim 11, wherein the known mensuration is an outside diameter.
